(19) United States
(12) Patent Application Publication
(10) Pub. No.: US 2019/0225190 A1
(43) Pub. Date: Jul. 25, 2019

(54) WINDSCREEN WIPER AND VEHICLE WITH WINDSCREEN WIPER

(71) Applicant: A. Raymond et Cie SCS, Grenoble (FR)

(72) Inventors: Jochen ZIMMER, Görwihl (DE); Karl BODE, Lörrach (DE)

(21) Appl. No.: 16/338,671

(22) PCT Filed: Oct. 10, 2017
(86) PCT No.: PCT/EP2017/001197

§ 371 Date: Apr. 1, 2019

(30) Foreign Application Priority Data
Oct. 12, 2016 (DE) 10 2016 012 099.1

(51) Int. Cl. B60S 1/04; B60S 1/32; B60S 1/52

(52) U.S. Cl. CPC B60S 1/0405; B60S 1/522; B60S 1/32; B60S 1/0463

(57) ABSTRACT

The present disclosure provides a windscreen wiper for a vehicle, the windscreen wiper having a wiper arm, a wiper blade, and a cover attached to the wiper arm. The windscreen wiper comprises at least one nozzle for windscreen washing fluid that forms part of the cover or is fastened to the cover. The-present disclosure also provides a vehicle comprising the windscreen wiper, a method of fastening the windscreen wiper to the vehicle, and a method of cleaning a windscreen of a vehicle.

### CROSS-REFERENCE TO RELATED APPLICATIONS

This application is the National Stage of International Application No. PCT/EP2017/001197, filed on 10 Oct. 2017, which claims priority to and all advantages of German Patent Application No. 10 2016 012 099.1, filed on 12 Oct. 2016, the content of which is hereby incorporated by reference.

### FIELD OF THE INVENTION

The invention generally relates to a windscreen wiper and, more specifically, a windscreen wiper for a vehicle having a front hood, a vehicle comprising the windscreen wiper, and methods that can be carried out with the windscreen wiper and vehicle.

### BACKGROUND OF THE INVENTION

DE 29708554 U1 discloses a housing for covering the windscreen wiper of a motor vehicle. A fixed housing part is formed trough-like in the tailgate. The lid is fixedly connected to the wiper arm and, in the rest position of the wiper arm, is connected substantially flush with the housing opening. If the rear window wiper is put into operation, it must first be moved linearly along the drive axis of the windscreen wiper in order to leave the housing trough. The focus here is protection of the wiper blade from dirt and reduced air resistance.

In today's vehicles, the hood is being moved ever closer to the windscreen. This has both aerodynamic reasons and pedestrian protection benefits. In designs with under-hood wash nozzles, this results increasingly in unfavorable angular positions with respect to the spray angle. The tolerances resulting from adjustment of the nozzle and fastening tolerances of the nozzle body are becoming smaller and smaller. Depending on the design, it is hardly possible to spray over the wiper blade.

### SUMMARY OF THE INVENTION

The present invention provides a design in which windscreen wiper fluid/water can be better applied to a windscreen to be cleaned and/or the aerodynamics can be improved.

In particular, the present invention provides a windscreen wiper for a vehicle, a vehicle, and related methods.

The windscreen wiper comprises a cover covering at least one region of a wiper arm and/or at least one region of a wiper blade of the windscreen wiper, and at least one windscreen washer nozzle formed as part of the cover or fastened to the cover. The cover is attached to the wiper arm, and thus the cover is moved with the wiper arm. By forming the nozzle as part of the cover, or by placing the nozzle on the cover, the nozzle is also moved with the wiper arm. This provides the ability to change the relative position of the nozzle relative to the windscreen and to bring the nozzle in positions advantageous for dispensing a windscreen washer fluid (i.e., a wiper fluid) via the nozzle. In particular, this provides the ability to move the nozzle over a vehicle windscreen during a wiping operation (i.e., a wiping movement), so that the wiper fluid can be applied in the vicinity of the wiper blade during the entire wiping process. In addition, the provision of the cover provides the ability to use the cover as a cover for a trough of a vehicle having an upper opening, which is bounded on one side by an edge of a front hood of the vehicle, has the front hood at an end facing the windscreen, and is bounded on the opposite side by a portion of the windscreen or by a portion of a frame which holds the windscreen. The windscreen wiper according to the invention offers the possibility of a nozzle system protected by the cover. The cover can prevent damage, soiling and rapid freezing of the nozzle.

In certain embodiments, the cover is attached to the wiper arm. Generally, the wiper arm is made so rigid as to follow a predetermined path during the wiping operation. By attaching the cover to the wiper arm, it is thus possible to move the nozzle, which is formed as part of the cover or attached to the cover, along a fixed path.

The wiper arm of the windscreen wiper may have a metal profile or a plastic profile. The metal profile or the plastic profile may have at least one linearly extending region. In some embodiments, the metal profile or the plastic profile has a first linearly extending region and a second linearly extending region. In some such embodiments, the first linearly extending region typically merges via a kink region into the second linearly extending region.

The wiper arm may comprise a fastening element (i.e., a fastening part) and a joint with which the metal profile or plastic profile is pivotally attached to the fastening element.

In certain embodiments, one end of the wiper arm comprises a hook adapted to engage a suspension frame of the wiper blade.

As such, the wiper blade may comprise such a suspension frame, which may be formed by two side frames of a central bracket.

The wiper blade may have a multi-unit support bracket system, which can be constructed with lower brackets mounted on the central bracket, which may comprise an end having a wiper strip with a fastening element, e.g. in the form of claws, on a head strip. The support bracket system may also comprise spring rails enclosed in the head strip to allow the wiper blade to be adapted to a curved windscreen during wiping with a largely uniform contact pressure, which can be supported by biasing a hinged joint via a tension spring. In certain embodiments, the wiper blade comprises a flexible head strip (e.g. instead of a multi-unit support bracket system). In particular embodiments, the wiper blade may be free from subordinate brackets, also called claw brackets, and intermediate brackets. In certain embodiments, the center bracket itself comprises claws, which can hold the wiper strip.

The wiper arm can be connected via the fastening part to a drive shaft (e.g. of a motor) which drives the wiper arm during the wiping movement. For this purpose, the fastening part may comprise a receptacle which can be connected to one end of the drive shaft, for example a receptacle comprising internal toothing which can be placed on a toothed drive shaft.

The cover generally covers at least a portion of the wiper arm and/or at least a portion of the wiper blade. In certain embodiments, the cover covers, in at least one viewing direction, at least 20%, alternatively at least 30%, alternatively at least 40%, alternatively at least 50%, alternatively at least 60%, alternatively at least 70%, alternatively at least 80%, alternatively at least 90% of the maximum cross section of the wiper arm in the at least one viewing direction. In these or other embodiments, the cover covers, in at least one viewing direction, at least 20%, alternatively at least 30%, alternatively at least 40%, alternatively at least 50%, alternatively at least 60%, alternatively at least 70%, alternatively at least 80%, alternatively at least 90% of the maximum cross section of the wiper blade in the at least one viewing direction. The maximum cross section of an object in a viewing direction is understood to be the area occupied by the silhouette of the object when the object is illuminated with light shining along the viewing direction.

In some embodiments, the maximum cross section of the cover, in at least one viewing direction, is more than 1.1 times, alternatively more than 1.2 times, alternatively more than 1.3 times, alternatively more than 1.4 times, alternatively more than 1.5 times, alternatively more than 1.6 times, alternatively more than 1.7 times, alternatively more than 1.8 times, alternatively more than 1.9 times, alternatively more than twice as large as the portion of the maximum cross section of the wiper arm covered by the cover in the at least one viewing direction. In certain embodiments, the maximum cross section of the cover, in at least in one viewing direction, is more than 1.1 times, alternatively more than 1.2 times, alternatively more than 1.3 times, alternatively more than 1.4 times, alternatively more than 1.5 times, alternatively more than 1.6 times, alternatively more than 1.7 times, alternatively more than 1.8 times, alternatively more than 1.9 times, alternatively more than twice as large as the portion of the maximum cross section of the wiper blade covered by the cover in the at least one viewing direction.

In some embodiments, the cover comprises a flat base body, e.g. comprising a width at least twice, alternatively at least fivefold, alternatively at least tenfold, alternatively at least twentyfold greater than a height of the flat base body and also a length that is at least twice, alternatively at least fivefold, alternatively at least tenfold, alternatively at least twentyfold, alternatively at least fiftyfold greater than a height of the flat base body. In certain embodiments, the at least one nozzle for windscreen washer fluid is a part of the base body and/or attached to the base body.

In particular embodiments, the base body is an elongate base body which extends along a longitudinal axis. In these or other embodiments, the maximum length of the base body in the direction of the longitudinal axis is at least 1.5 times, alternatively at least twice, alternatively at least threefold greater than a maximum width of the cover measured in a direction perpendicular to the longitudinal axis.

In certain embodiments, the cover has a smooth outer surface. A smooth outer surface is understood in particular to mean a surface which has no steps and/or from which no further elements protrude. Typically, the smooth outer surface is flat or curved. In particular embodiments, no nozzle is provided on the outer surface is free from a nozzle (i.e., none of the at least one nozzle for windscreen washer fluid protrudes from the outer surface). The outer surface may be used as an outward-facing surface, e.g. when the cover is used to close the trough of a vehicle. When the smooth outer surface is utilized as the outward-facing surface, aerodynamic benefits may be provided in such applications.

In some embodiments, the outer surface of the cover is made plan, wherein the term “plan” is understood that the outer surface lies in a plane. Such embodiments may be utilized when the cover extends from a substantially planar extending portion of the front hood adjacent the windscreen to the windscreen. Likewise, such embodiments may be utilized when the trough is arranged in a region of a rear window, a roof, or a pillar of the vehicle, or in an area of a door, tailgate, or luggage compartment lid of the vehicle, e.g. when a section of such a component adjoining the trough is designed plan and should be extended and/or covered by the cover. Likewise, the outer surface of the cover may comprise a three-dimensional shape, such that the cover is or comprises a design element. For example, in such embodiments, the cover may be utilized to as a transition from such a component of the vehicle adjacent to the trough, to the windscreen, e.g. as a design element and/or an element to improve aerodynamics. For example, the cover can be part of an outer appearance of an A-pillar of the vehicle. Likewise, the three-dimensional shape of the outer surface can be used to form a spoiler, or other aerodynamic element, e.g. that affects the contact pressure of the windscreen wiper on the windscreen to be wiped.

In certain embodiments, the base body has a peripheral edge comprising a sealing lip. In such embodiments, e.g. when the cover is used to close the trough of the vehicle, the sealing lip can be used to increase the tightness of the closure.

In some embodiments, the cover comprises metal or a plastic. The cover may comprise integrated nozzles, channels, openings, and/or cavities, e.g. which can be produced by injection molding in plastic. To avoid restricting the view of a driver of the vehicle, the cover of the windscreen wiper may comprise, alternatively may consist of in a particular portion, a substantially transparent material, e.g. a substantially transparent plastic. Additionally, the cover may comprise, e.g. in part, a rubbery and/or elastic material, such as for sealing the edges of the cover (e.g. in a rest position).

In general, the windscreen wiper comprises at least one nozzle for washer fluid. In some embodiments, the at least one nozzle forms part of the cover or is attached to the cover. In the context of this disclosure, a “nozzle” is also understood to include a bore. For example, a fluid-conducting channel may be implemented within a component (for example the cover), in a wall of which the bore is located or otherwise defined, and the washer fluid can escape through the bore. As another example, a hose may be fastened to a component (for example the cover), in the wall of which the bore is located, and the washer fluid can escape through the bore.

In some embodiments, a plurality of bores may be provided, in particular at different locations of the wall of the channel and/or the wall of the hose, as described above, such as at a plurality of locations arranged successively in a flow direction of the washer fluid when viewed through the channel or the bore. The bore diameter can vary, for example, to influence the exiting amount of the washer fluid. For example, bores that are closer to a lower portion of the windscreen during operation of the windscreen wiper may be made larger, so that there will be more washer fluid spread over the windscreen by the air stream, while bores closer to an upper region of the windscreen can be made smaller to minimize wiper fluid loss when excess washer fluid is carried by the air stream above the upper frame of the windscreen. The size of the bore may be adapted to the wiper fluid emerging from the bore, for example, to harmonize the pressure.

The nozzle may comprise or compose a rigid outlet. Examples include configurations where the bore is utilized as the nozzle, the nozzle is utilized as an insert in the bore, the nozzle is utilized as an insert that generates an oscillating fan jet or a non-oscillating fan jet, and combinations thereof.

The nozzle may comprise an adjustable insert, e.g. an insert that can be adjusted between settings directly with a tool from the outside and/or indirectly with a set screw.

In some embodiments, at least two, alternatively at least three, alternatively at least four, alternatively at least five, alternatively at least six, alternatively at least seven nozzles for washer fluid form part of the cover and/or are attached to the cover. In certain embodiments, not more than 30, alternatively not more than 25, alternatively not more than 20, alternatively not more than 15, alternatively not more than 10 nozzles for windscreen washer fluid form part of the cover or not more than 30, alternatively not more than 25, alternatively not more than 20, alternatively not more than 15, alternatively not more than 10 nozzles are attached to the cover.

In particular embodiments, a first nozzle is provided on at least one side of the wiper arm and a second nozzle is provided on the cover, or as part of the cover, on an opposite side of the wiper arm. In some embodiments, a first nozzle is provided on at least one side of the wiper blade and a second nozzle is provided on the cover, or as part of the cover, on an opposite side of the wiper blade. In such embodiments, i.e., with nozzles on both sides of the wiper blade, the nozzles may be controlled individually, e.g. via a plurality of hoses and/or electrical valves supplied to the windscreen wiper. Typically, a spraying of the windscreen (e.g. with the washer fluid, via the nozzle) is predominantly realized on a side of the wiper blade pointing in the direction of movement, so that a rubber lip of the wiper blade remains at least substantially wetted by the washer fluid. Further advantages for wetting the wiper blade, in which mainly the surface ahead of the wiper blade is wetted, include minimizing the visual obstruction of the driver, protecting the wiper blade and the windscreen , and using an optimal amount of the washer fluid, which is primarily directed only where it is needed.

In certain embodiments, the channels and/or hoses supplying the washer fluid and the nozzles are located underneath the cover (e.g. on a side opposite the outer surface of the cover). The fastening of these elements can be done on the cover, e.g. via adhesive and/or latching fastening methods. In some embodiments, the channels and/or hoses may be located and/or fastened on the wiper arm and/or the wiper blade.

In some embodiments, the windscreen wiper comprises one or a plurality of hoses on both sides of the wiper blade, which hoses are initially guided substantially along the wiper arm before they are guided along the wiper blade and/or the cover. The hoses may have openings in which the nozzles and/or bores are located.

In certain embodiments, the exit of the washer fluid takes place at least substantially at the end and/or at the beginning of the wiper arm. For this purpose, at least one nozzle is located at a region of the cover adjacent to the ends of the wiper arm. Typically, this nozzle can generate a wiping water jet at least in parts parallel to the longitudinal axis of the wiper blades.

In particular embodiments, the wiper arm, wiper blade, and cover are reversibly detachable from each other. This can reduce the cost of expendable parts of the windscreen wiper.

In some embodiments, the windscreen wiper comprises one or a plurality of heating elements, which may be provided for heating the washer fluid-carrying components. This can be done electrically via wires on the channels and/or in the nozzles.

The wiper arm of the windscreen wiper typically has a linearly extending region which extends in the direction of the longitudinal axis of the windscreen wiper. In certain embodiments, the maximum longitudinal extension of the wiper blade in one direction is substantially parallel to the longitudinal axis, wherein the cover covers at least the linearly extended region of the wiper arm.

In some embodiments, the cover covers at least the linearly extended region of the wiper arm and at least a predominant region of the wiper blade.

In certain embodiments, the cover has one or a plurality of kinks or folds, along which the cover can be folded and unfolded via a folding or unfolding process, respectively, particularly during operation of the windscreen wiper, into a compact, space-saving state in order to limit the field of vision of a driver by as little as possible. The folding and unfolding process can be effected via different methods. For example, in some embodiments, the cover may comprise a mechanism comprising spring-biased joints located in the folds. At the beginning of the operation of the windscreen wiper, the folding process can then be initiated and executed electromechanically, for example. In these or other embodiments, the folding process can take place via an override control. The folding and unfolding processes of the cover are typically carried out in such a way that the driver's view is optimized and the function of the windscreen wiper is not restricted.

In some embodiments, the cover may comprise a shape memory material, which assumes a flat shape in the rest position and assumes a compact, for example, rolled-up shape during operation of the windscreen wiper.

In certain embodiments, the shape of the cover between the windscreen and the component of the vehicle adjacent to the trough (e.g. a vehicle exterior part) is variable, e.g. may self-adjust or be adjusted to the windscreen wiper in an analogous manner as described above, in order to close the trough (or a gap) in a flush manner.

The vehicle according to the invention comprises:

a windscreen;

a further component;

a trough between the further component and the windscreen, wherein the trough has an upper opening that is delimited on one side by an edge of the further component at an end of the further component facing the windscreen, and is delimited on an opposite side by a portion of the windscreen or by a portion of a frame that holds the windscreen; and

a windscreen wiper for the windscreen, the windscreen wiper comprising a wiper arm, a wiper blade, and a cover attached to the wiper arm;

wherein the wiper arm and the wiper blade can be arranged in the trough in an operating state of the windscreen wiper and/or an operating state of the vehicle, and;

wherein in the operating state of the windscreen wiper (e.g. where the wiper arm and the wiper blade are arranged within the trough), the cover or a part of the wiper arm itself closes at least a portion of the upper opening of the trough such that a portion of the edge of the cover or of the wiper arm touches (e.g. contacts) the further component at the end facing the windscreen and is at the opposite portion of the cover in contact with the windscreen or the frame (e.g. at least a portion thereof) that holds the windscreen.

In some embodiments, the vehicle according to the invention comprises a front hood (i.e., the further component comprises, alternatively is, the font hood) and the windscreen, and comprises the trough between the front hood and the windscreen. In such embodiments, the trough has an upper opening that is delimited on one side by the edge of the front hood, has the front hood at an end facing the windscreen, and is delimited on the opposite side by the portion of the windscreen or by the portion of the frame that holds the windscreen. Further, the windscreen wiper for the windscreen is provided with a wiper arm and a wiper blade, wherein the wiper arm and the wiper blade can be disposed in the trough between the front hood and the windscreen in an operating state of the windscreen wiper (e.g. during an operating state of the vehicle).

The vehicle further comprises a cover, which is fastened or fixed to the wiper arm, wherein in the operating state (also called the idle state) of the windscreen wiper (e.g. in which the wiper arm and the wiper blade are arranged within the trough), the cover or a part of the wiper arm itself closes at least a portion of the upper opening of the trough between the front hood and the windscreen, such that a portion of an edge of the cover or the wiper arm touches the front hood at an end facing the windscreen and an opposite portion of the cover contacts the windscreen or a portion of the frame that holds the windscreen.

In particular embodiments, the further component comprises, alternatively is, a portion of the roof of the vehicle, a portion of a pillar of the vehicle (e.g. a pillar which is closest to the windscreen, otherwise known as an A-pillar, or a pillar which is closest to the rear window, otherwise known as a last pillar), or a portion of a door, tailgate, or trunk lid of the vehicle.

In general embodiments, the vehicle the vehicle comprises the windscreen wiper according to the embodiments described above, with like parts (e.g. the wiper arm, wiper blade, and cover) being implemented in the various ways also described.

In general, the windscreen wiper is used for windscreens. In certain embodiments, two juxtaposed windscreen wipers (e.g. a first and a second windscreen wiper) can be used to wipe a larger area. In such embodiments, the cover of one of the two juxtaposed windscreen wipers (e.g. the first windscreen wiper) in the idle state is configured at least substantially complementary to the cover of the other windscreen wiper (e.g. the second windscreen wiper) so that a largely closed surface between the windscreen and the vehicle hood (e.g. over the trough) is formed. In particular embodiments, a portion of the cover of the first windscreen wiper can cover a part of the second, adjacent windscreen wiper.

In the operating state of the windscreen wiper (e.g. during wiping), the windscreen wiper leaves the closure position, in particular by a rotational movement about the axis of the drive shaft of the motor.

In some embodiments, the vehicle further comprises an axle and a drive capable of rotating the axle, wherein the wiper arm is attached to one end of the axle. In such embodiments, the end of the axle may be arranged in the trough, e.g. underneath the cover, such that when the cover closes at least a portion of the upper opening of the trough in the operating state of the windscreen wiper the wiper arm and the wiper blade are arranged within the trough.

In some embodiments, the vehicle according to the invention may further comprise a pump, a water tank, and nozzles. For example, the pump may be adapted to deliver the washer fluid, e.g. with pressure from the water tank, via water pipes to the nozzles.

A method of using the windscreen wiper on a vehicle (e.g. a motor vehicle) is also provided. The method comprises providing a vehicle, and cleaning the windscreen of the vehicle with the windscreen wiper. In some embodiments, the vehicle is the vehicle described in the embodiments above.

In certain embodiments, cleaning the windscreen of the vehicle with the windscreen wiper is adapted to the properties of the assembly of the windscreen wiper. For example, the windscreen wiper may be equipped with a mechanism that allows easy lifting of the windscreen wiper with the cover from the idle position. For this purpose, the folding mechanism of the cover may be designed to allow the lifting of the windscreen wiper from the idle position without a rotational movement component about the axis of the drive motor.

A method of installing the windscreen wiper is also provided, and includes attaching the windscreen wiper to a vehicle. The method may be used to assemble or otherwise prepare the vehicle described in various embodiments above.

A further method for cleaning a windscreen of a vehicle is also provided. The method comprises providing the windscreen wiper in the operating state (e.g. in which the wiper arm and the wiper blade are arranged within the trough) raising the cover from the upper opening of the trough, and moving the wiper arm and the wiper blade from the trough and at least partially over the windscreen. Typically, the cover is raised from the upper opening of the trough via moving the wiper arm and the wiper blade from the trough.

In certain embodiments, the windscreen wiper is held in position by a rotational movement into latching or clamping in the idle position, and freed automatically only by an opposite rotational movement from the latching position. In such embodiments, the windscreen wiper may be unlocked from outside and/or inside the vehicle (e.g. for cleaning and/or inspecting of the windscreen wiper.

### BRIEF DESCRIPTION OF THE DRAWINGS

The invention is described in greater detail below with reference to the accompanying figure, in which:

FIG. 1 shows a section through the front region of a vehicle with a front hood, a windscreen wiper according to the invention in a trough, and a windscreen;

FIG. 2 shows perspective front views, obliquely, from above on the front region of a vehicle, showing different operating situations of the windscreen wiper of the vehicle;

FIG. 3 shows a plan view of a windscreen wiper according to the invention with a wiper arm, a wiper blade and a cover;

FIG. 4 shows a side view of a windscreen wiper according to the invention with a wiper arm, a hose, nozzles and a cover;

FIG. 5 shows a side view of a windscreen wiper according to the invention with a wiper arm, a wiper blade and a folded cover;

FIG. 6 shows a plan view of a windscreen wiper according to the invention with two folds in the cover;

FIG. 7 shows a plan view of a windscreen wiper according to the invention with two hoses for nozzles on the backside of the cover;

FIG. 8 shows sections through a windscreen wiper according to the invention with two folds in the cover, showing different operating situations of the windscreen wiper;

FIG. 9 shows sections through a windscreen wiper according to the invention with two hinges in the cover, showing the different operating situations of the windscreen wiper; and

FIG. 10 shows a section and perspective view of a nozzle for fastening to a fluid channel.

### DETAILED DESCRIPTION

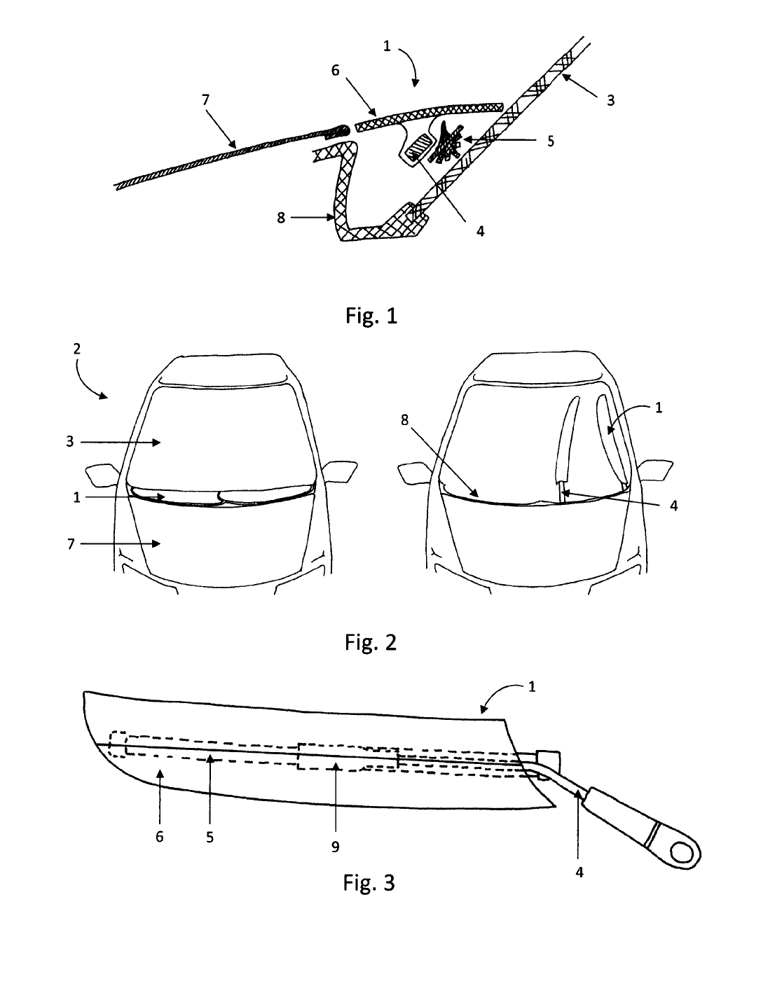

Referring to FIGS. 1-10, wherein like numerals indicate corresponding parts throughout the several views, a windscreen wiper is illustrated and generally designated 1. In particular, in accordance with certain embodiments, a section through a front region of a vehicle 2 is shown in FIG. 1. The vehicle 2 comprises a front hood 7 made of metal or plastic, the windscreen wiper 1 in a trough 8, and a windscreen 3. The front hood 7 may terminate flush with the trough 8. Both components can be fastened to each other in particular by clamping or latching. The trough 8 is fixedly connected with a further component of the vehicle 2 to the opposite side of the front hood 7 in particular with the frame or the windscreen 3 itself. The connection may be adhesive, wherein latching and/or clamping may also be utilized. The trough 8 and the gap between the windscreen 3 and front hood 7 is at least substantially covered and filled by the windscreen wiper 1 and, in particular, a cover 6 of the of the windscreen wiper 1. The cover 6 may terminate flush with both outer edges of the trough 8, such that a predominantly smooth transition from the front hood 7 to the windscreen 3 is provided (e.g. to offer increased aerodynamics and/or minimize risk of injury to pedestrians). Optionally, the cover 6 of the windscreen wiper 1 closes the trough 8 tight to ensure maximum protection against contamination or driving noise.

As shown in FIG. 2, in accordance with particular embodiments, the vehicle 2 may comprise windscreen 3, front hood 7, and two adjacent windscreen wipers 1, in two configurations (at left and at right). The left configuration of FIG. 2 shows the windscreen wipers 1 not in operation, and therefore in an idle position. It can be seen that the associated covers 6 of the windscreen wipers 1 at least partially cover the region between the front hood 7 and the windscreen 3. Furthermore, mutually complementary edges on the joint of the two covers 6 can be seen in plan view. The right configuration of FIG. 2 shows the windscreen wipers 1 in an operating state and rotated about 90°, leaving open the trough 8. The visual obstruction during the wiping process is reduced in particular by the foldable covers 6 of the windscreen wiper 1, which may be made of and/or comprise partially transparent materials.

As shown in the FIG. 3, in accordance with some embodiments, the windscreen wiper 1 comprises a wiper arm 4 and a wiper blade 5 in addition to the cover 6. The cover 6 may be wide relative to the wiper arm 4, and is typically mounted over the wiper blade 5 and wiper arm 4. Typically, the cover 6 is connected to the wiper arm 4 via a reversible fastener, such as a clamp, screw or a quick-release fastener. The outer contour of the cover 6 may be formed slightly sickle-shaped on the side facing away from the wiper arm 4, e.g. to allow a smooth insertion of the windscreen wiper 1 into the idle position. The tip of the cover 6 may cover a part of the adjacent windscreen wiper 1. In the viewing direction of FIG. 3, the cover 6 may cover at least 70% of the maximum cross section of the wiper blade 5 in this direction of the view and/or at least 70% of the maximum cross section of the wiper arm 4 in this direction of the view.

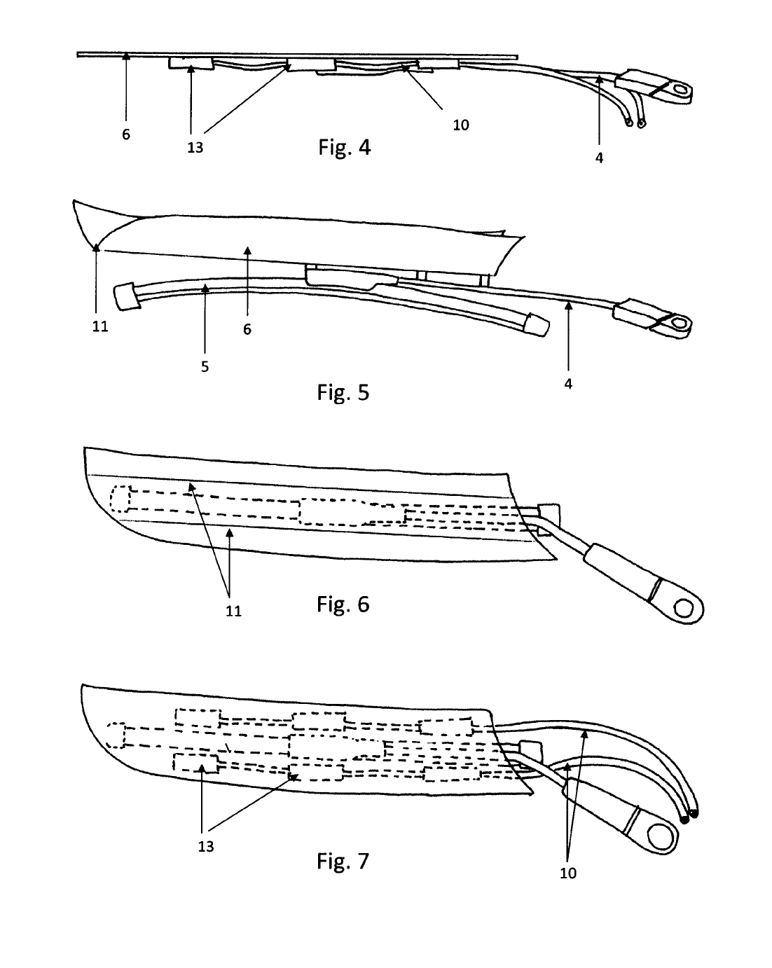

As shown in FIG. 4, in accordance with some embodiments, the windscreen wiper 1 may comprise, e.g. in addition to wiper arm 4 and the cover 6, hoses 10 (or fluid channels) for supplying windscreen washer fluid, and nozzles 13. The cover 6, which may be designed to be largely planar, may hold the hoses 10 on an underside. The hoses 10 are typically adapted to guide windscreen wiper water to the nozzles 13, which can be located along the entire windscreen wiper

As shown in FIG. 5, in accordance with certain embodiments, the cover 6 has a fold or kink 11, which is typically at least substantially parallel to the wiper arm 4 and is more or less centered in the transverse direction. The material composing the cover 6 may comprise metal and/or plastic, e.g. a transparent plastic. In certain embodiments, the cover 6 comprises a shape memory material, which folds up for operation (e.g. via fold 11) and is unfolded in the idle position. Such folding of the cover 6 can be carried out electrically and/or electromechanically, e.g. via pneumatic drives or the like. In some embodiments, the folding mechanism can be purely mechanical, for example via spring-loaded, preloaded hinges 9, which are triggered or adjusted particularly via a positive mechanism, and are generally shown in FIG. 3. In certain embodiments, an elastic material is utilized to provide a required restoring force for the cover 6. In general, the cover 6 comprises a sufficient dimensional stability to resist strong wind. Accordingly, the folded state of the cover 6 is typically as compact as possible/practical and comprises a low air resistance coefficient (CW value), which can be taken into account in particular by rounded edges.

In certain embodiments, as shown in FIG. 6, the windscreen wiper 1 may comprise two of more folds 11 in the cover 6, e.g. to achieve a particularly compact folded state in the operating state. In addition, the two or more folds 11 or kinks allow for increased adaptability for closing the trough 8 in the idle position, particularly when the cover 6 comprises rigid materials such as metal in conjunction with hinges 12 in the folds 11, as shown in FIG. 9 and described below.

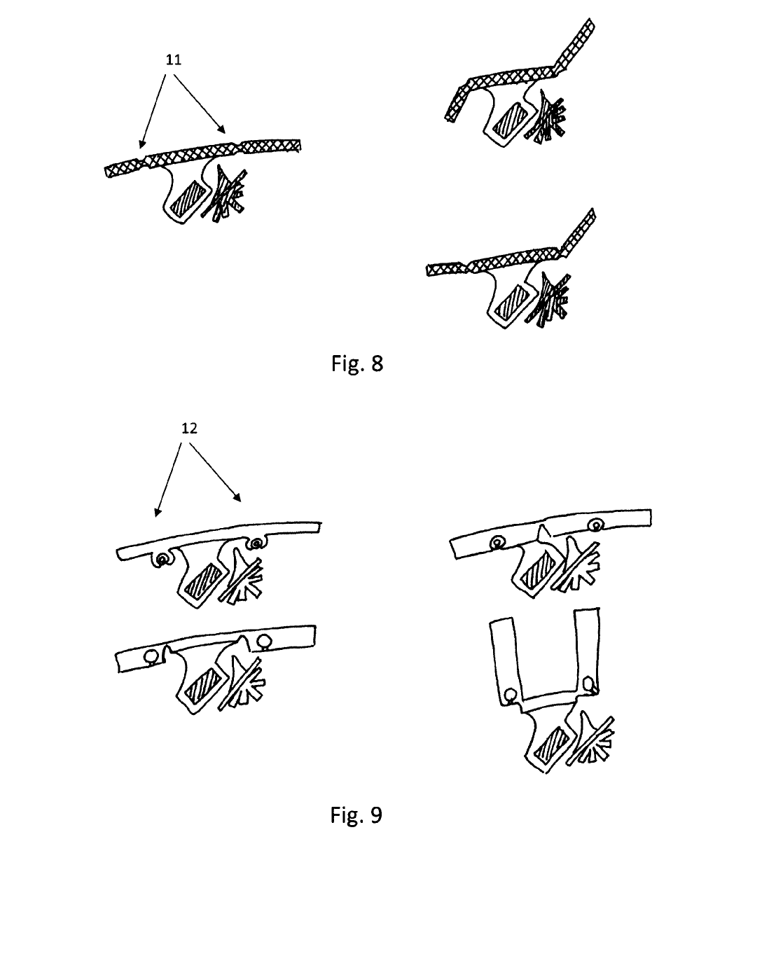

As shown in FIG. 7, in accordance with particular embodiments, the windscreen wiper 1 may comprise two of the hoses 10 attached to the underside of the cover 6 for supplying washer fluid to the nozzles 13, which may also be located protected on a rear side of the cover 6. In these exemplary embodiments shown, the hoses 10 are provided to give a fluid channel on both sides of the wiper blade 5, which may be supported at three locations, e.g. via a clamping or latching connection. The nozzles 13 may optionally be located on a bracket. In certain embodiments, the nozzles 13 may be distributed along one or more of the hoses 10.

In general, the components of the windscreen wiper 1 for cleaning the windscreen are well protected against damage, even during operation by a rear-sided mounting of the windscreen wiper 1, and allow a uniform and economical distribution of the washer fluid. In addition, the rubber-like lamella of the wiper blade 5 is spared, since the wiper blade 5 is typically wetted by water/fluid when operating the windscreen wiper system 1.

In certain embodiments, as shown in FIG. 8 and as introduced above, the windscreen wiper 1 may comprise the folds 11 in the cover 6 as linear kinks, which allow the cover 6 to bend during operation in that direction, which is advantageous in particular for reasons of space and aerodynamics. In FIG. 8, an unfolded state is shown on the left, while conceivable position states during operation of the windscreen wiper 1 on a mostly oblique implementation of the windscreen 3 are illustrated on the right.

As shown in FIG. 9, in accordance with some embodiments, the one or two kinks 11 for folding the cover bare realized via rotatably mounted elements such as hinges 12. The hinges 12 allow for a folding up of both lateral elements of the cover 6 in the operating state.

In certain embodiments, as illustrated at the bottom right in FIG. 9, alignment of a bore in the nozzles 13 from which the washer fluid emerges (collectively, the “bores”) in a direction in which the washer fluid exits can be influenced within the lateral elements of the cover 6 (e.g. downward for a left-hand channel and diagonally downward to the right for the right-hand channel shown at the bottom right in FIG. 9). The windscreen wiper 1 may comprise the cover 6 with variable lateral elements, which can also be used to change the orientation of the washer fluid jet (e.g. from the nozzles 13).

Based on the particular orientation of the bore in the left channel in the embodiments exemplified by the configuration shown at the bottom right in FIG. 9, the bore can be protected from dirt if the lateral element of the cover 6 in which a corresponding one of the nozzles 13 is located is pivoted from a vertical position shown (e.g. as in the configuration shown at the bottom right in FIG. 9) into a position in which the left side element is horizontal.

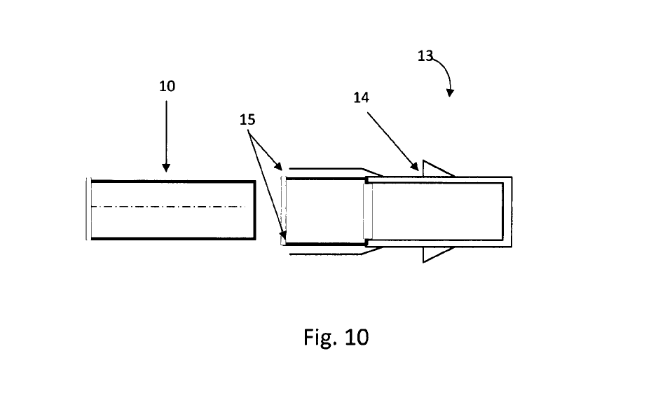

As shown in FIG. 10, in accordance with certain embodiments, the nozzle 13 may comprise a nozzle outlet 14 for connection to the hose 10, as may typically be used underneath the cover 6. The nozzle 13 may comprise an end cap or connecting element 15 for fluid channels, e.g. which can be installed via adhesive, hot-glue, and/or clamp/fastener. The fluid, which is typically supplied by the washer fluid/water, may be pressurized by an associated pump as described above. As such depending on the arrangement of the components described above, the windscreen wiper may provide the washer fluid to cover an angle range of almost 360°, e.g. when nozzle-like outlets (e.g. nozzle outlets 14) are aligned in the rearward direction.

What is claimed is:

1. A windscreen wiper for a vehicle, the windscreen wiper comprising a wiper arm, a wiper blade, and a cover fastened to the wiper arm, wherein the cover covers at least one region of the wiper arm and/or at least one region of the wiper blade, and wherein at least one nozzle for windscreen washing fluid forms part of the cover or is fastened to the cover.

2. The windscreen wiper of claim 1, wherein the cover comprises an integrated supply of wiping fluid to the at least one nozzle.

3. The windscreen wiper of claim 1, wherein a hose for windscreen washer fluid fastened to the cover, and wherein the wiper arm and/or the wiper blade are arranged on the backside of the cover.

4. The windscreen wiper of claim 1, further comprising a heating element for heating a windscreen washer fluid-carrying component.

5. The windscreen wiper of claim 1, wherein: (i) the wiper blade is detachable from the wiper arm; (ii) the cover is detachable from the wiper arm; or (iii) both (i) and (ii).

6. The windscreen wiper of claim 1, wherein the cover has a fold along which the cover can be folded from a flat state to a compact, space-saving state.

7. The windscreen wiper of claim 1, wherein the cover comprises a substantially transparent material.

8. The windscreen wiper of claim 1, wherein the wiper arm comprises a linearly extending region that extends in the direction of a longitudinal axis of the wiper arm; wherein the maximum longitudinal extension of the wiper blade is substantially parallel to the longitudinal axis of the wiper arm; and wherein the cover covers at least the linearly extending region of the wiper arm.

9. A vehicle comprising:
a windscreen;
a further component;
a trough between the further component and the windscreen,
wherein the trough comprises an upper opening that is delimited on one side by an edge of the further component at an end of the further component facing the windscreen and is delimited on an opposite side by a portion of the windscreen or a portion of a frame that holds the windscreen; and
a windscreen wiper for the windscreen comprising a wiper arm, a wiper blade, and a cover fastened to the wiper arm;
wherein the wiper arm and the wiper blade are arranged in the trough in an operating state of the windscreen wiper; and
wherein in the operating state of the windscreen wiper at least a part of the upper opening of the trough is closed by the cover or the wiper arm such that a part of the cover or the wiper arm touches the end of the further component facing the windscreen and an opposite part of the cover contacts the windscreen or the frame that holds the windscreen.

10. The vehicle of claim 9, wherein the windscreen wiper is the windscreen wiper of claim 1.

11. The vehicle of claim 9, further comprising an axle and a drive capable of rotating the axle, wherein the wiper arm is mounted at one end of the axle, and wherein the end of the axle is arranged in the trough in the operating state of the windscreen wiper.

12. A method of using a windscreen wiper on a vehicle, said method comprising:
providing a vehicle, wherein the vehicle is the vehicle of claim 9; and
cleaning the windscreen of the vehicle with the windscreen wiper.

13. A method comprising fastening a windscreen wiper to a vehicle, wherein the windscreen wiper is the windscreen wiper of claim 1.

14. A method for cleaning a windscreen of a vehicle, said method comprising:
providing a vehicle, wherein the vehicle is the vehicle of claim 9;
providing the windscreen wiper in the operating state, in which the wiper arm and the wiper blade are arranged within the trough;
raising the cover from the upper opening of the trough; and
moving the wiper arm and the wiper blade out of the trough and at least partially over the windscreen.
